(19) United States
(12) Patent Application Publication
(10) Pub. No.: US 2026/0233577 A1
(43) Pub. Date: Aug. 13, 2026

(54) METHOD FOR OPERATING A HEATING SYSTEM OF A VEHICLE

(71) Applicant: MERCEDES-BENZ GROUP AG, Stuttgart (DE)

(72) Inventors: Valentin MAIER, Ispringen (DE); Benno STAMP, Stuttgart (DE)

(21) Appl. No.: 19/111,953

(22) PCT Filed: Jul. 12, 2023
(86) PCT No.: PCT/EP2023/069408

§ 371 Date: Mar. 14, 2025

(30) Foreign Application Priority Data
Sep. 16, 2022 (DE) 10 2022 003 426.3

(51) Int. Cl. B60H 1/00; B60H 1/22; B60N 2/56

(52) U.S. Cl. CPC B60H 1/00742; B60H 1/2226; B60N 2/5678

(57) ABSTRACT

A heating system of a vehicle includes a panel heating element with several heating regions and is arranged on at least one interior component. The heating system determines the position of a vehicle occupant located on a vehicle seat, determines the heating requirement of a vehicle occupant located on a vehicle seat, and specifies the heating power of the heating regions of the panel heating element assigned to a vehicle seat as a function of the heating requirement of the vehicle occupant determined at least using the position of the occupant on the vehicle seat.

### BACKGROUND AND SUMMARY OF THE INVENTION

Exemplary embodiments of the invention relate to a method for operating a heating system of a vehicle.

Usually, to heat the interior in vehicles operated with internal combustion engines, the waste heat of the internal combustion engine is used for heating systems which control the temperature of the entire interior of the vehicle through convention. In particular, it is no longer possible to heat the interior in this way in electrically operated vehicles, meaning that alternative heating methods and heating systems have to be used here.

In particular, heating systems that control the temperature of the interior of the vehicle by radiant heat are also considered for these alternative heating methods. In these heating systems, heat is generated by thermal radiation (infrared radiation) in a targeted manner and locally at a specific point in the vehicle, i.e., heating the entire interior of the vehicle as in the case of heating by convection is no longer required.

On the topic of heating the interior of vehicles, a method for automatically setting a locally perceived temperature in a camping vehicle through radiant heat is disclosed in DE 10 2021 103 399A1 . In this known method, a plurality of electrical panel heaters are integrated into flat accessories at different usage areas in the interior of the camping vehicle. The heating power of at least one of these electrical panel heaters is regulated and/or controlled as a function of the exact location of a person located in the interior of the camping vehicle. In particular, laminates, ceiling coverings or wall coverings, furniture, doors or similar objects are provided as flat accessories in the interior of the camping vehicle.

An arrangement for heating a vehicle interior, in particular a rail vehicle interior, is known from DE 10 2019 202 223A1 , in which infrared surface radiant heaters are arranged in the interior to heat the vehicle interior. The infrared surface radiant heaters are designed as components integrated into surfaces of the interior.

Systems and methods for radiating heat by PTC radiant panels are specified in U.S. Pat. No. 11,363,683 B2. A radiant heating system for heating an occupant of an enclosed space comprises panels for emitting heat into the enclosed space in the direction of the occupant. A power supply supplies electrical power to the panels. A control device controls the electrical power supplied to the panels, based on a temperature in the enclosed space and the positions of the panels in the enclosed space.

US 2015/0028119 A1 relates to a method for heating the interior of a vehicle, in particular a hybrid or electrical vehicle, wherein the vehicle has a central heating system and several decentralized heating surfaces designed as infrared radiators, and the vehicle interior can be temperature-controlled by the central heating system and/or the decentralized heating surfaces according to a heating requirement of at least one vehicle occupant. According to the invention, to control the temperature of the interior by means of the decentralized heating surfaces, the heating power of at least one decentralized heating surface is specified or influenced as a function of the position of the vehicle occupant or a body part of the vehicle occupant relative to the respective decentralized heating surface or to a defined group consisting of several decentralized heating surface.

Further relevant documents are DE 11 2016 006 238 T5 , JP 2009 178 247 A, DE 11 2016 006 238 T5 , DE 10 2013 009 516 A1 and U.S. Pat. No. 10,875,428 B2.

Furthermore, a radiant heating device for a vehicle is known from EP 2 578 423 B1 , in which a radiant heater interacting with an air conditioning system of the vehicle has a plurality of heating sections, which each radiate heat into regions of the lower body of a vehicle passenger, independently of each other.

Based on this known prior art, exemplary embodiments of the invention are directed to a generic method for operating a heating system of a vehicle, with which the heating power can be adjusted conveniently and individually for a vehicle occupant in a simple manner.

In the method according to the invention, for operating a heating system, the interior of the vehicle is heated in a targeted manner by thermal radiation with at least one panel heating element, which is arranged on an interior component of the vehicle, and which has several heating regions. In particular, at least one panel heating element is assigned to a vehicle seat and is preferably arranged in the vicinity of this vehicle seat, so that a specific area surrounding the vehicle seat can be heated or temperature-controlled with at least one panel heating element with several heating regions.

Here, any surface of an interior component of the vehicle can be provided as a receiving surface for a panel heating element with several heating regions. Preferably, these receiving surfaces for a panel heating element with several heating regions are oriented in the direction of a respective vehicle occupant. For example, panel heating elements with several heating regions can be provided in the backrest part (seat back) of a front seat of a vehicle for the occupants in the rear of the vehicle and/or panel heating elements with several heating regions can be provided on a door panel of a side door of the vehicle and/or panel heating elements with several heating regions can be provided in a footwell of the vehicle and/or panel heating elements with several heating regions can be provided on the instrument panel of the vehicle and/or panel heating elements with several heating regions can be provided on the center console of the vehicle and/or panel heating elements with several heating regions can be provided on the headliner of the vehicle.

Furthermore, for a vehicle occupant located on a vehicle seat, the current position of this occupant on the vehicle seat is determined, in particular relative to the radiant surface of the heating regions of the at least one panel heating element assigned to this vehicle seat. This means that a significant variable that influences the individual heating requirement of an occupant on a vehicle seat is taken into account when specifying the heating power of the respective panel heating element.

For this purpose, the sitting position and/or the posture and/or the position of specific limbs of the vehicle occupant located on a vehicle seat is determined and is taken into account when specifying the heating power of the respective panel heating element and its heating regions. For example, it is determined whether this occupant is sitting on the vehicle seat with their legs wide apart or more with their legs together on the vehicle seat, or whether the occupant has their arms folded or not folded on the vehicle seat, for example, or whether the occupant is sitting upright on the vehicle seat or adopting more of a reclining posture on the vehicle seat, etc.

Furthermore, the physical characteristics or personal parameters of the vehicle occupant located on a vehicle seat are determined and taken into account when specifying the heating power of the respective panel heating element and its heating regions. Physical characteristics of this type of the vehicle occupant located on a vehicle seat, if necessary, can represent relevant variables that have an influence on the individual current heating requirement of an occupant on the vehicle seat. In particular, in this case, the body size of the vehicle occupant located on a vehicle seat and/or the clothing state of the vehicle occupant located on a vehicle seat can be determined and taken into account when specifying the heating power of the respective panel heating element and its heating regions. This prevents, for example, a tall vehicle occupant who, due to their height, is sitting close to the panel heating elements and their heating regions from being too warm due to the then strong heating by the heating regions of the panel heating elements and a short vehicle occupant who, due to their shorter height, is sitting further away from the panel heating elements and their heating regions from being too cold due to the then weak heating by the heating regions of the panel heating elements.

When taking into account the clothing state of the vehicle occupant sitting located on a vehicle seat, it can be assumed, for example, that the individual current heating requirement in the leg area is lower for a vehicle occupant wearing shorts than for a vehicle occupant wearing long trousers or that the individual current heating requirement is greater for a vehicle occupant wearing a jacket than for a vehicle occupant not wearing a jacket.

To determine the position of the vehicle occupant on the vehicle seat and to determine the physical characteristics of the vehicle occupant, a sensor unit designed as a capacitive sensor unit and/or a sensor unit designed as an optical sensor unit and/or a sensor unit designed as a lidar sensor unit and/or a sensor unit designed as an ultrasound sensor unit and/or a sensor unit designed as a seat occupancy sensor unit is provided, wherein a sensor unit and in particular a capacitive sensor unit can be arranged on a panel heating element or on the interior component of the vehicle accommodating a panel heating element.

When specifying the heating power of a panel heating element and, in particular, the individual heating regions of the panel heating element, the specific individual situation of the vehicle occupant on the vehicle seat is therefore also taken into account by considering the current position of the vehicle occupant located on the vehicle seat and preferably also by considering the physical characteristics of the vehicle occupant located on the vehicle seat. In particular, the individual heating regions of a panel heating element are controlled differently depending on the current situation of the vehicle occupant on the vehicle seat and are thus activated or not activated, i.e., remain switched off, or their heating power is adjusted individually depending on the situation.

The heating power of the at least one panel heating element is specified by a control device of the vehicle, which regulates and/or controls the voltage and the current of the respective panel heating element and, in particular, also of the individual heating regions of a panel heating element according to the determined heating requirement of the respective vehicle occupant located on a vehicle seat, at least taking into account the occupant's position on the vehicle seat.

An optical sensor unit and/or a capacitive sensor unit and/or a thermal sensor unit is provided to determine the heating requirement of a vehicle occupant located on a vehicle seat.

By means of a thermal imaging camera as a thermal sensor unit for determining the heating requirement of the vehicle occupant located on a vehicle seat, the surface temperature of at least one illuminated body part of this occupant can be detected. Based on the respective surface temperature of the body parts of the vehicle occupant, the heating requirement for the respective body part of the vehicle occupant can then be inferred and the heating power of the heating regions of at least one surface heating element assigned to this vehicle seat can be controlled or regulated accordingly, taking into account the position of the vehicle occupant on the vehicle seat and, if necessary, taking into account the physical characteristics of the vehicle occupant, such as their body size or clothing state.

By means of an optical camera provided as an alternative to the thermal sensor unit or in addition to the thermal sensor unit as an optical image acquisition unit of an optical sensor unit for determining the heating requirement of the vehicle occupant located on a vehicle seat, the distance between at least one body part of this occupant and the at least one panel heating element assigned to this vehicle seat or the heating regions of the panel heating element is detected and the heating requirement of this occupant is derived from this and, in particular, the heating requirement of different body parts of this occupant is also derived. In particular, it can also be taken into account that the thermal energy absorbed by the vehicle occupant depends on the distance to the radiation source and thus on the distance to a panel heating element, assigned to this vehicle seat, or to the heating regions of the panel heating element. As with the direct determination of the surface temperature of illuminated body parts of a vehicle occupant located on the vehicle seat, it can also be taken into account here that different body parts of a vehicle occupant may have different heating requirements, for example there may be a significantly different heating requirement between the head area and the foot area of a vehicle occupant. The heating power of the heating regions of at least one panel heating element assigned to this vehicle seat is controlled or regulated accordingly depending on this and taking into account the position of the vehicle occupant on the vehicle seat and, if necessary, taking into account the physical characteristics of the vehicle occupant, such as their body size or clothing state.

A capacitive sensor unit is preferably provided to detect the distance between the at least one body part of the vehicle occupant and the at least one panel heating element or to the heating regions of the panel heating element. This capacitive sensor unit can be arranged in a panel heating element, i.e., integrated in the panel heating element and for this purpose be designed, for example, as a capacitive circuit in the panel heating element, or arranged on a panel heating element or arranged in the area between a panel heating element and a vehicle seat or integrated in a vehicle seat or arranged on a vehicle seat.

Alternatively, other sensor units utilizing measuring methods can also be provided for detecting the distance between the at least one part of the occupant's body and the at least one panel heating element or to the heating regions of the panel heating element, in particular also a combination of different sensor units of this type.

The panel heating elements of the vehicle's heating system that are provided in the vehicle and their heating regions can be part of a common heating circuit of the heating system or at least partially integrated in separate and thus mutually separated heating circuits of the heating system.

This means that the different panel heating elements of the vehicle's heating system and, in particular, the individual heating regions of the respective panel heating elements of the vehicle's heating system can also be controlled individually in a simple manner depending on the current heating requirements of a vehicle occupant sitting on a vehicle seat.

In particular, it can also be prescribed in this way that only those panel heating elements of the heating system of the vehicle and, in particular, only those heating regions of the panel heating elements that can also reach a vehicle occupant and their body parts or limbs located on a vehicle seat with radiation can be activated and can thus contribute to the thermal comfort for a vehicle occupant located on a vehicle seat. As the unneeded panel heating elements and their heating regions are inactive or remain deactivated, the resulting energy savings can also increase the overall efficiency of the vehicle's heating system.

Advantageously, with the invention presented, a high level of thermal comfort for the occupants of the vehicle can be realized by taking into account different variables that have an influence on the current heating requirement of a vehicle occupant and the heating power of the individual heating regions of panel heating elements specified from this, thus creating a pleasantly tempered environment for the occupants of the vehicle.

Since the activation state and also the heating power of the individual heating regions of the panel heating elements are individually specified for the occupants of the vehicle and adequately for the respective application or the current boundary conditions in the interior of the vehicle, the interior of a vehicle can be heated very efficiently and in an energy-saving manner, preferably selectively, which is also highly relevant for the range of electrically powered vehicles in particular.

By taking into account significant individual and characteristic variables that have an influence on the current heating requirement of a vehicle occupant and the specified heating power of individual heating regions derived therefrom, the heating power of the panel heating element overall can be reduced in many use cases, which contributes to further increasing the efficiency of the heating system.

Further advantages, features and details of the invention can be seen from the following description of a preferred exemplary embodiment and with reference to the drawing with the figures.

The features and combinations of features mentioned above in the description as well as the features and combinations of features mentioned below in the description of the figures and/or shown in the two figures alone can be used not only in the combination indicated in each case, but also in other combinations or on their own, without leaving the scope of the invention.

### BRIEF DESCRIPTION OF THE DRAWING FIGURE

In the figures:

FIG. 1 shows a schematic illustration of the interior of a vehicle with a vehicle occupant in a specific sitting position on a rear seat of the vehicle; and

FIG. 2 shows a further schematic illustration of the interior of a vehicle with a vehicle occupant in another sitting position on a rear seat of the vehicle.

### DETAILED DESCRIPTION

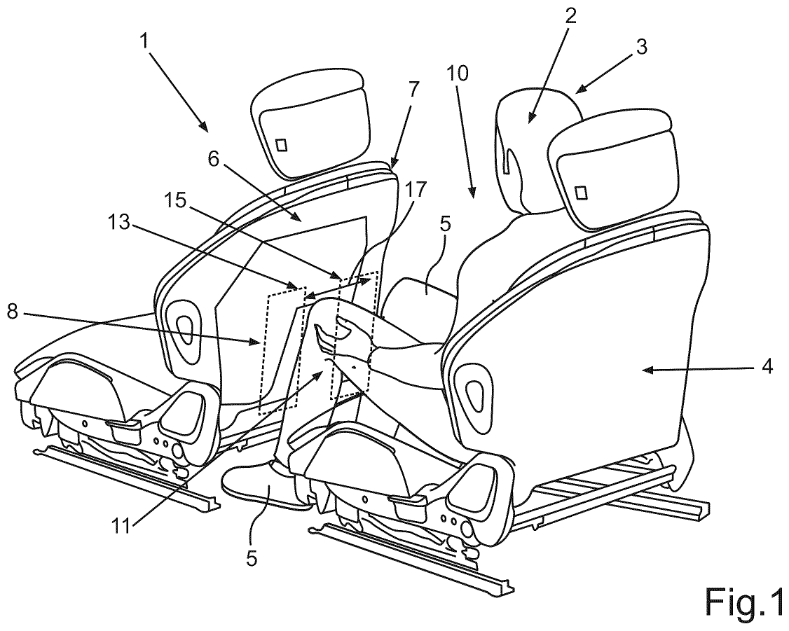

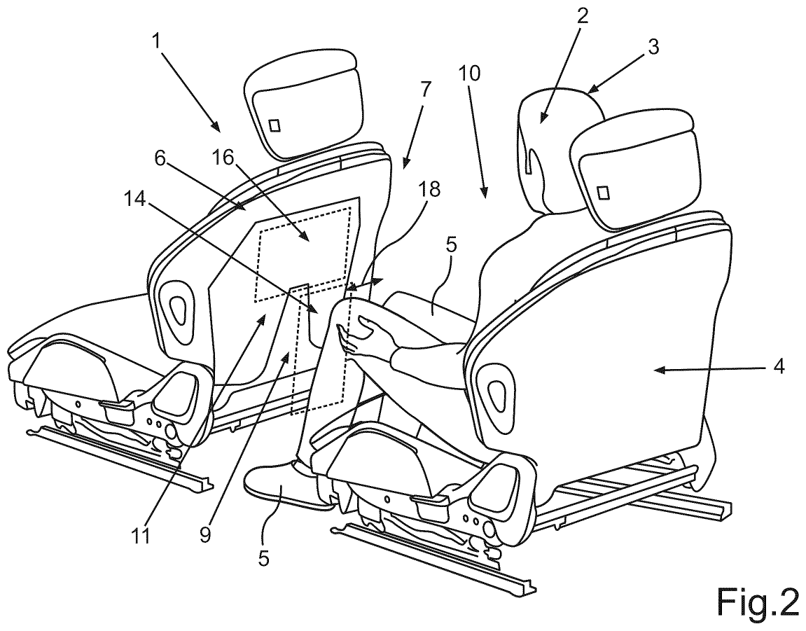

FIGS. 1 and 2 each show a schematic diagram of a partial region of the interior 1 of a vehicle with an occupant 2 located in the rear compartment 3 of the vehicle on a rear seat 4 of the vehicle.

The occupants 2 shown in FIG. 1 and FIG. 2 sit in a different sitting position on the rear seat 4 of the vehicle.

The occupant 2 shown in FIG. 1 sits with their legs apart on the rear seat 4 of the vehicle, so that the legs 5 of the occupant 2 are also relatively wide apart from each other at quite a large distance 17 and more in the outer region 8 of the front seat 7 of the vehicle.

The occupant 2 shown in FIG. 2 sits with their legs together on the rear seat 4 of the vehicle, so that the legs 5 of the occupant 2 are also relatively close to each other at a short distance 18 and more in the central region 9 of the front seat 7 of the vehicle.

At specific positions in the interior 1 of the vehicle, panel heating elements 11 with several heating regions 13, 14, 15, 16 are arranged on interior components of the vehicle adjacent to the vehicle seats 4, 7 of the vehicle, the radiant surfaces of the panel heating elements are preferably oriented towards the respective vehicle seat 4, 7 of the vehicle.

In particular, for individually heating specific areas 10 for an occupant 2 located on the rear seat 4 of the vehicle, a panel heating element 11 with several heating regions 13, 14, 15, 16 is provided on the backrest 6 of the front seat 7 of the vehicle, which is integrated, for example, in the backrest tensioning part 12 in the backrest 6 of the front seat 5 of the vehicle.

For individually specifying the heating power for the occupant 2 on a rear seat 4 of the vehicle, for example by a control device of the vehicle, the position of the occupant 2 on the rear seat 4 and in particular also the sitting position of the occupant 2 on the rear seat 4 is determined; for example, among other things, the position of the legs 5 of the occupant 2 in relation to the front seat 7 of the vehicle is determined. This determination of the sitting position of the occupant 2 on the rear seat 4 can be carried out, for example, by an optical camera arranged, for example, in the region of the vehicle roof, for example is integrated into the headliner of the vehicle, or which is arranged in the region of the center console of the vehicle.

According to FIG. 1, the distance 17 between both legs 5 of the occupant 2 on the rear seat 4 in this legs-apart sitting position is quite large, so that only the two outer heating regions 13, 15 in the area of the legs 5 of the occupant 2 are activated with the panel heating element 11 to heat the leg area of the occupant 2, for example the two heating regions 13, 15 of the panel heating element 11 each having a heating power of 200 W. The two other heating regions 14, 16 of the panel heating element 11 are not activated, so that only the heating regions 13, 15 of the panel heating element 11 contributing to heating the legs 5 of the occupant 2 need energy.

According to FIG. 2, the distance 18 between both legs 5 of the occupant 2 on the rear seat 4 in this closed-legs sitting position is quite small, so that only the central heating region 14 in the area of the legs 5 of the occupant 2 is activated with the panel heating element 11 to heat the leg area of the occupant 2, for example the heating region 14 of the panel heating element 11 having a heating power of 250 W. The two outer heating regions 13, 15 of the panel heating element 11 are not activated, so that only the heating region 14 of the panel heating element 11 contributing to heating the legs 5 of the occupant 2 needs energy.

Additionally, in the illustration of FIG. 2, the heating region 16 of the panel heating element 11 located in the upper part of the backrest tensioning part 12 in the backrest 6 of the front seat 5 of the vehicle is also activated, and thus the area of the upper half of the body of the occupant 2 on the rear seat 4 is also heated through targeted thermal radiation. For this purpose, a heating power of the heating region 16 of the panel heating element 11 is specified with a value of 180 W.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-4. (canceled)

5. A method for operating a heating system of a vehicle, wherein the heating system includes at least one panel heating element with several heating regions, is arranged on an interior component of the vehicle, and is assigned to a vehicle seat, the method comprising:
determining, by a first sensor unit, a sitting position, a posture, or a position of limbs of a vehicle occupant located on a vehicle seat, wherein the first sensor unit is a capacitive sensor unit, an optical sensor unit, a lidar sensor unit, an ultrasound sensor unit, or a seat occupancy sensor unit;
determining physical characteristics of the vehicle occupant located on a vehicle seat;
determining, by the optical sensor unit or the capacitive sensor unit, a distance between at least one body part of the vehicle occupant and the panel heating element;
determining, by a second sensor unit, a heating requirement of the vehicle occupant located on a vehicle seat, wherein the second sensor unit is a further optical sensor unit, a further capacitive sensor unit, or a thermal sensor unit; and
specifying a heating power of the several heating regions of the at least one panel heating element assigned to the vehicle seat as a function of the heating requirement of the vehicle occupant determined at least using the position of the vehicle occupant on the vehicle seat, the physical characteristics of the vehicle occupant, and the distance between the at least one body part of the vehicle occupant and the panel heating element.

6. The method of claim 5, wherein the thermal sensor unit detects a surface temperature of the at least one body part of the vehicle occupant located on a vehicle seat.

7. The method of claim 5, wherein a control device of the vehicle specifies the heating power of the heating regions of the at least one panel heating element.

8. The method of claim 5, wherein the at least one panel heating element with several heating regions is arranged
on a backrest of a front seat of the vehicle,
on a door panel of a side door of the vehicle,
in a footwell of the vehicle,
on an instrument panel of the vehicle,
on a center console of the vehicle, or
on a headliner of the vehicle.
